(19) United States
(12) Patent Application Publication
(10) Pub. No.: US 2003/0230373 A1
(43) Pub. Date: Dec. 18, 2003

(54) Engineered tire particle aggregates and constructs

(76) Inventor: Peter J. Ianniello, Havre De Grace, MD (US)

Correspondence Address: Venable, P.O. Box 34385, Washington, DC, 20043-9998, US

(21) Appl. No.: 10/066,678

(22) Filed: Feb. 6, 2002

Related U.S. Application Data
(60) Provisional application No. 60/266,467, filed on Feb. 6, 2001.

(51) Int. Cl. B32B 1/00

(52) U.S. Cl. 156/71; 156/95

(57) ABSTRACT

Aggregates and constructs made from pieces of recycled tires, and engineered for drainage and other construction purposes are provided. The present particle aggregates and constructs can be designed and manufactured with defined gradations and engineering properties to allow for the specifically desired engineering parameters such as permeability, compressibility, rigidity, compactability, density, and resistance to movement and other frictional characteristics. Embodiments of the invention can be created to have defined engineering properties that can be maintained for desired lengths of time, such as compressibility and permeability to the flow of gases or liquids. Thus, the present invention can have myriad embodiments, configurations and properties depending upon the exact engineering construction environment in which a particular embodiment will be used. Embodiments of the present invention advantageously can be used in place of earthen materials or in addition to earthen materials and can be used in conjunction with various construction materials like pipe and culverts. Whether adhered together, or positioned as loose aggregates, the present aggregate systems can form part of a greater subsurface system that provides reinforcement, separation, and drainage for a structure and thereby extends its useful life.

### FIELD OF THE INVENTION

The present invention relates generally to creating engineered construction materials from recycled tire rubber for the purpose of complimenting or substituting for engineered earthen materials such as soil, gravel or stone in whole or in part when those materials are used to provide or impede drainage, compaction, density, on construction projects. Aggregates and constructs made from pieces of recycled tires, and engineered for drainage and other construction purposes are provided. The present particle aggregates and constructs can be designed and manufactured with defined gradations and engineering properties to allow for the specifically desired engineering parameters such as permeability, compressibility, rigidity, compactability, density, and resistance to movement and other frictional characteristics. Embodiments of the invention can be created to have defined engineering properties that can be maintained for desired lengths of time, such as compressibility and permeability to the flow of gases or liquids. Thus, the present invention can have myriad embodiments, configurations and properties depending upon the exact engineering construction environment in which a particular embodiment will be used. Embodiments of the present invention advantageously can be used in place of earthen materials or in addition to earthen materials and can be used in conjunction with various construction materials like pipe and culverts. Whether adhered together, or positioned as loose aggregates, the present aggregate systems can form part of a greater subsurface system that provides reinforcement, separation, and drainage for a structure and thereby extends its useful life.

### BACKGROUND OF THE INVENTION

The building of large structures such as landfills, foundations, roadways, buildings, parking lots, retaining walls, embankments and the like often involves the excavation, re-contouring and other movement of large quantities of earthen materials such as soil, rock, earth, gravel, sand and the like. Earthen materials often must have defined physical, mechanical, and hydraulic properties in order to be selected for use in a design for a structure.

Earthen materials are often used to provide drainage around foundations, as fill materials in retaining walls; landfill cap drainage soils, landfill leachate collection systems, landfill leachate detection systems, landfill gas venting systems, foundation drainage systems, and as fill material in roads and embankments. Earthen material drainage systems are constructed in vertical, diagonal, and horizontal manners to provide for gravity based fluid transmission as opposed to conveying fluid by mechanical means. The weight of earthen materials and the fact that they are typically not bound together requires extensive subgrade preparation to occur in order to create firm underlying foundations to support the static or dynamic weight of the structure and thereby stabilize the earthen material drainage system in its desired position with respect to the earth and with respect to other parts of the same structure. For example, roadways and parking lots usually have foundations comprising a base aggregate immediately under the paved surface, and a subgrade layer under the base aggregate which supports the weight of both of the overlying structures. Commonly, both the base aggregate and subgrade are formed of stones, soil and other earthen materials which have been transported to the site of the structure and subjected repeatedly to grading, tamping or other compressive operations and thereby formed into a foundation of desired elevation, inclination and direction. Buildings commonly have concrete foundations for their walls, or concrete slabs that support the weight of the overlying structure. New landfills cells designed to receive waste typically have soil or stone leachate collection and detection systems and while landfill caps constructed at closure use sand or stone as gas venting systems and surface water removal systems.

The presence of water or other fluids near, within or under such foundations and structures can be quite disadvantageous. Earthen-engineered materials are often selected and evaluated on how desirable their respective engineering properties are under various moisture content conditions. For example, if an earthen material is selected to be used around a foundation, but it retains water, and does not have the ability to release the fluid to designated discharge points in a timely manner, a basement can become completely saturated. If a soil is used on top of a geomembrane that physically is hydroscopic meaning it retains fluids, than undesirable surcharges can damage a geomembrane.

Engineered earthen materials like clay are often compacted to construct facilities to contain fluid or prevent fluid entry. Still, engineered earthen materials like sand, stone, or gravel are often selected to transport fluids to designated discharge points in a timely manner. Engineers design with these types of earthen materials by specifying that these materials be of certain uniform or non-uniform gradations. Different types of soils that have uniform gradations can be engineered to transport fluids to collection systems like pipes. Still, engineers can also specify mixtures or combinations of various earthen materials like sand, stone, gravel in order to obtain a non-uniform gradation in order to reduce ability to transport fluids; yet engineered earthen systems of this nature provides less potential soil particle movement when dynamic or static loads are applied. This would be the case in road applications. Such movement can result in the failure of the underlying materials to support the overlying traffic. It is thus important to control the movement of the materials underlying large structures and in the vicinity of and underlying the foundations of such large structures.

One way of controlling such movement is to require gradations of soil and stone that are easily compactable and have non-uniform gradations so the materials have the tendency to fill in voids left behind by larger particles. Reinforcing products such as frameworks, which are integral to the materials underlying the foundation, or within it, also may be used to impede such undesired movement. Geosynthetic rolled good materials are often used to provide such a framework.

Earthen materials such as gravel and sand are used as fill, stabilization, and drainage materials on large man-made structures. In such uses, the purpose is to contain, drain, or provide strong foundation materials. Earthen materials have a long track record and are commonplace in these applications. However, earthen materials often have shortcomings; certain aggregate like limestone is not chemically compatible with and rapidly breaks down when exposed to fluids that have certain ph ranges. Certain types of sands may allow fluids to pass, but retain relatively high moisture contents; clays have great compressive strength under certain moisture contents, but are relatively weak when fully saturated.

To overcome some of these challenges, manufacturers of earthen-engineered materials process stone, sand, and gravel in order to create manufactured materials with defined physical, mechanical, and hydraulic properties. Earthen engineered materials are created through a process of mining, washing, and sizing in order to create materials with certain gradations and engineering properties for use in construction applications. This is a multibillion-dollar industry with significant material specification standardization and thousands of sites exist around the country to provide engineers and contractors with materials. Often times, the earthen material specifications are defined by regional departments of transportation as well as Federal Highway Administration, and the American Association of Safety and Highway Transportation Officials.

The aforementioned process creates materials suitable for use within specific geographic markets. However, these materials are not easily transportable, nor are they economically transportable. Engineered earthen material availability is in large part determined by regional geological conditions. For example, finding a stone quarry in Florida is challenging. However, earthen stone is quarried in Georgia and shipped to many Florida locations by rail. Many quarries are reaching the end of their useful lives. Establishing new quarries is often difficult due too stringent environmental regulations.

These are some of the particular problems faced by waste impoundment facilities, FHWA, DOT's and many highway and transportation agencies. Availability, transportability, relates to cost of these engineered earthen materials. Thus, particular problems faced by engineers seeking suitable earthen materials with desirable engineering properties relates to procuring. Engineered earthen materials such as soil, gravel, or stone can be difficult depending upon the desired properties and geologic conditions. For instance, it is difficult to procure stone of consistent quality in many coastal areas. Non-earthen materials such as geosynthetics have been used successfully as means of improving engineering properties of earthen materials. Geosynthetic products are produced of polymer roll goods and are deployed on project sites in a manner that allows the materials to be unrolled and then sewn, tied, or welded together. It is known that tire chips have been tried in certain construction applications. These tire chips have been used when engineers, contractors, or owners have simply attempted to convert randomly received tires into chips with little or no attention to considering the very characteristics of the rubber as a source of raw material whose mechanical and physical properties like density, tensile strength, chemical resistance, and compressive resistance, actually varies dependent upon tire producer (Firestone or Michelin), type of tire (snow or all season) and mile ratings (25,000 or 100,0000). Producing tire chips on an ad-hoc basis will continue after Tire Aggregate is offered to the market. However, no business process exists to allow tire chips in existing form to become a suitable alternative technology to engineered earthen materials. Currently, no tire chip producer creates specification for use in this application and supports material property claims with material warranties and product liability coverage. Currently, no tire chip producer offers value added engineering services to demonstrate to potential users how tire chips may be used and/or supports the value added process with design software available on the internet.

Currently, no commercialization effort exists that create tire chips with engineered properties attractive for designers as a result of planned industrial procedures whose implementation yields desirable engineering properties on a consistant repeatable, and reproducable basis due to stringent raw material acceptance guidelines, manufacturing quality control and manufacturing quality assurance plans. Currently, no commercialization effort exists that provide users with software and design methodologies that technically demonstrate for a customer how to replace natural materials with Tire Aggregate. Currently, no mass commercialization methodology exists requiring tires to be qualified as a “raw material” prior to chipping with strong raw material selection criteria when the criteria is known and planned to effect quality and perfinance in the intended end use. Currently, no commercializations efforts exist that communicate preferred installation methods and needed appurtances and provide software supported technology transfer methods demonstrating how products are design compatable with geosynthetics and pipes. Currently, no commercialization exists that provide customers with material property certifications, warranty provisions, or product liability coverage designed to support commercialization claims that the tire chip producers product is a suitable substitute for engineered earthen materials used to either convey or impede fluids. Currently, designers cannot use materials with confidence.

The present invention effectively addresses many of these problems because TPA is unique because it creates an alternative technology that can replace or compliment earthen materials. TPA is unique because it is capable of mass commercialization. Mass commercialization is defined as creating a standardized product line that can be marketed utilizing value added engineering marketing techniques to create mass demand and satisfying mass demand with sufficient quantities of TPA products fully supported by design and material warranties and product liability. Therefore, there is a very big difference between ad-hoc use of tire chips and the planned commercialization of Tire Particle Aggregate through this unique business process. Tire Particle Aggregate desired properties are resultant from specifying raw materials and semifinished material production and selection procedures that will yield desirable finished good properties of designed physical, hydraulic, dimensional, and mechanical properties when stringently followed. This unique business process allows TPA to be standardized with predictable performance values and allows mass amounts of customers across wide geographic regions to consider TPA as an alternative to engineered earthen materials because TPA's business process includes design representations, material warranties and certifications guaranteeing predictable compressive behaviors, frictional strengths, porosity, permeability, chemical resistance, density, compact-ability, hydraulics, tensile properties, thickness, unit weight, shape, and color. Moreover, the present invention offers a use for used tires and, thus, offers a solution to a serious disposal/recycling problem.

The present invention includes processes that allow for the conversion of used or discarded vehicle tires into particles of known size, density and compressibility to thereby form categories of particles. Known proportions of the categories of particles are then mixed to arrive at a Tire Particle Aggregate (“TPA”) of desired characteristics with respect to, for example, void space per unit volume, compressibility of individual particles, and overall compressibility of the aggregate.

TPA's of desired characteristics can be used as drainage fill in close proximity to the foundations of large structures such as landfills, houses, office buildings, roadways, parking lots and factories. TPA's also can be combined with geotextiles and other foraminous, impermeable or scrobiculate geomembranes in numerous ways to form drainage structures useful for protecting those structures from flooding and water damage. For example, TPA's can be layered over, under or between geotextiles to form customized drainage structures of desired shape and volume.

TPA's according to the invention can be formed of tire particles that have been pre-processed to alter their characteristics. For example, tire particles used to form TPA's of the invention can be heated to temperatures sufficient to drive off more volatile hydrocarbons to thereby alter the properties of the particles in a desired way while recovering the hydrocarbons for recycling. Thus, the present invention can use tire particles already processed by other recycling industries to form valuable TPA's.

Additional embodiments of the invention include bonded tire particle aggregates (“BTPA's”) of fixed or nearly fixed shape. BTPA's are formed by bonding tire particles, of uniform or aggregate sizes, to one another by means of heat or adhesive compounds to thereby form a drainage structure of desired shape and size. Such BTPA drainage structures can be constructed in a factory, on site, or in place around a building foundation, for example and can be delivered to projects in sealed cans, drums or buckets, in open dump trucks, or in rolled good form.

BTPA's can also be used as permanent internal concrete forms or plugs. For example, a BTPA of desired shape and size could be surrounded with a relatively impermeable membrane and then used to determine the internal shape and size of a concrete drainage structure. In some such embodiments, the tire particles are left in place to provide drainage of desired volume and pore size.

### SUMMARY OF THE INVENTION

The present invention overcomes the previously mentioned disadvantages by creating a product line; produced from a business process, that provides a sustainable source of synthetically produced materials with similar performance characteristics as certain types of commonly used natural earthen engineered soil materials like certain types of sand, stones and gravels. The present invention is thereby capable of use in conjunction with, or to complement these same earthen materials such as soil, gravel, or stone to be marketed on a national basis. Structures of the present invention are Tire Particles Aggregates and TPA and can dramatically reduce the costs of constructing certain types of structures while maintaining or improving performance and design confidence.

According to the invention, TPA can be constructed and positioned within the identical section of a structure where engineered earthen materials are often used. A principal object of the present invention is to provide cost-effective alternatives to the use of engineered earthen materials. This is accomplished by a business process that creates a national standard of specifications for recycled tire producers; the standard identifies the gradations of tire particle sizes that must be produced to convert tire particles into an engineered material for use on construction sites.

An additional object of the invention is to define for tire recyclers specific quality and specification requirements in order to produce TPA materials of sufficient physical, mechanical, hydraulic, characteristics to include compact-ability, compress-ability, angularity, frictional, permeability, and porosity to allow for mass replacement of earthen engineered materials like sand, stone, or gravel. It is principal object of the present invention to transfer certain quality control aspects of manufacturing engineered earthen materials to the manufacturing facilities used to produce TPA. It is yet another object of the present invention to provide a predictable amount of subsurface drainage as part of a complete drainage system to transport fluid to designated discharge points in a timely manner.

In accordance with this and other objects, the present invention provides a drainage system for draining fluids away by comprising a porous matrix of TPA wherein TPA maintain their relative positions and provides sufficient porosity under variances in static and dynamic loads such that fluids from the structure can move freely through the TPA to designated discharge points in manners defined by engineers.

The TPA may be placed adjacent to or comprised of different gradations to increase or decrease levels of porosity. TPA systems may incorporate one or more fluid-transmissible geotextiles, geocomposites, geogrids, polymeric tensile elements in roll or random form, or geomembrane within, beneath, or above the TPA. TPA may also further comprise drain means adjacent to it and communicating therewith such that the fluid can move from the TPA to the drain means, wherein the drain means is sloped preferably downwardly from the TPA.

In some preferred embodiments of the present invention, the TPA may be filled around the circumference of perforated piping and the perforated piping is connected to further drains means wherein the further drain means is one or more selected from the group consisting of non-perforated pipes, drainage ditches, sumps, canals, streams and rivers.

In accordance with additional advantageous aspects of the invention, the TPA is constructed and arranged in a manner similar to the placement of engineered earthen materials and placed, as one of skill in the art will recognize to carry away a sufficient volume of fluid collected through the relatively large surface area of the TPA.

Moreover, by interconnecting the various portions of the present invention such that the various interconnecting TPA voids maintain flow paths for fluid such as water entering the system, large areas of landfill caps, leachate collection systems, highways, foundations and concrete slabs can be effectively drained without the necessity of complex and expensive earthen-engineered drainage systems. Of course, as one of skill will recognize, the present invention is particularly advantageous for draining water-containing fluids or other geologic fluids to designated discharge points within or around the structure.

In accordance with other aspects of the present invention, TPA particles may go through other processing techniques that will either increase or decrease the flexibility, hardness, and compressibility of the TPA. For example, the TPA may go through heat treatment systems and chemical additive systems to enhance desired properties of the specified TPA gradations.

The TPA of the present invention will be made in gradations for example, in particles designed to be placed at specified levels with bulldozers and other conventional construction equipment.

Other advantages of the present invention are found in the methods that it provides. The present invention includes methods for providing drainage systems for landfills, roadways or other large structures. For example, the present invention provides a method for constructing a drainage system for draining fluids away from a roadway or other large structure, the method comprising providing a porous TPA and that porous structure is created and can be modified by specify the distribution and uniformity of TPA particle size.

The means and methods of the present invention include the positioning of the geocomposites and drain means in many permutations depending on the particular needs of the structure to be drained. For example, TPA can be positioned to replace earthen-engineered materials in subterranean drainage systems. Moreover, the present methods include allowing the TPA to be used with combinations of earthen-engineered materials, thereby creating earthen synthetic materials that are composite systems to obtain desired system properties that may be desirable on a project.

As a further advantage, the combinations and methods of the invention comprise wherein the TPA may be used with lower quality earthen materials native to the site or mixed with imported materials.

### BRIEF DESCRIPTION OF THE DRAWINGS

FIG. 1 is a cross-sectional view of a preferred embodiment of the TPA with a gradation similar to the AASHTO classification of engineered earthen materials.

FIG. 2 is a detailed cross-sectional view of the TPA in landfill applications.

FIG. 3 is a cross-sectional view of the present invention in a roadway.

FIG. 4 is a cross-sectional view of TPA used in conjunction with foundations and retaining walls.

FIG. 5a is a cross-sectional view of TPA used in conjunction with engineered earthen materials to produce a composite system.

FIG. 5b is a cross-sectional view of TPA used in conjunction with perforated collection pipes.

In accordance with additional advantageous aspects of the invention, the TPEC is constructed and arranged in a manner similar to the placement of engineered earthen materials and placed, as one of skill in the art will recognize to carry away a sufficient volume of fluid collected through the relatively large surface area of the TPEC.

Moreover, by interconnecting the various portions of the present invention such that the various interconnecting TPEC voids maintain flow paths for fluid such as water entering the system, large areas of landfill caps, leachate collection systems, highways, foundations and concrete slabs can be effectively drained without the necessity of complex and expensive earthen engineered drainage systems. Of course, as one of skill will recognize, the present invention is particularly advantageous for draining water-containing fluids or other geologic fluids to designated discharge points within or around the structure.

In accordance with other aspects of the present invention, TPEC particles may go through other processing techniques that will either increase or decrease the flexibility, hardness, and compressibility of the TPEC. For example, the TPEC may go through heat treatment systems and chemical additive systems to enhance desired properties of the specified TPEC gradations.

The TPEC of the present invention will be made in gradations for example, in particles designed to be placed at specified levels with bulldozers and other conventional construction equipment.

Other advantages of the present invention are found in the methods that it provides. The present invention includes methods for providing drainage systems for landfills, roadways or other large structures. For example, the present invention provides a method for constructing a drainage system for draining fluids away from a roadway or other large structure, the method comprising providing a porous TPEC and that porous structure is created and can be modified by specify the distribution and uniformity of TPEC particle size.

The means and methods of the present invention include the positioning of the geocomposites and drain means in many permutations depending on the particular needs of the structure to be drained. For example, TPEC can be positioned to replace earthen-engineered materials in subterranean drainage systems. Moreover, the present methods include allowing the TPEC to be used with combinations of earthen-engineered materials, thereby creating an earthen synthetic materials that is a composite systems to obtain desired system properties that may be desirable on a project.

As a further advantage, the combinations and methods of the invention comprise wherein the TPEC may be used with lower quality earthen materials native to the site or mixed with imported materials.

Thus, the present invention provides, inter alia,

A means of turning tire particles into engineered materials to substitute for earthen materials on construction projects.

i) Particles will be manufactured into engineered materials for use in civil engineering applications by processing tire rubber through various chopping and cutting mechanisms in order to create tire rubber particles of specified size and gradations.

ii) and these particulate materials will be produced in defined gradations to create gradations of particulate materials with desirable engineering properties such as, compressive strength, frictional characteristics, porosity, permeability, chemical compatibility, density, and compactability; and these engineering properties are defined with a series of short term index tests and long term performance tests with durations of at least 100 hours in order to define the long term effects that variance in sustained and dynamic loading conditions will have on desired engineering properties.

iii) and passing particles through additional stages such as heat treatment, chemical additives, and or chemical immersion can further enhance the particular engineering properties or any combinations thereof in order to enhance or reduce desired engineering properties.

iv) and the particulate gradations of materials can be used in a manner that specifies uniformity of particle size to create desired porosities and permeability under various loads to be used in drainage system design on construction projects and these uniform TPEC gradations can maintain porosity and permeability levels for durations of time that equal design lives of various structures

v) and those TPEC systems are used to store and transport fluid in geotechnical applications to designated discharge points across diagonal, horizontal, or vertical surfaces in a timely manner.

vi) and the particulate gradations of materials can be used in a manner that specifies non-uniformity in order to create TPEC systems with decreased porosity levels, increase densities, compact ability and for durations of time that equal design lives of various structures.

vii) And the particulate gradations may be used in conjunction with earthen materials to create composite systems of natural and synthetic materials with desirable engineering properties.

viii) And TPEC systems may be placed on top or along side prepared subgrades; membranes; geotextiles; geocomposites; waterproofing systems; foundations; concrete slabs.

ix) And TPEC systems may be placed directly in certain types of native subgrades to improve or enhance the construct ability of the native subgrades.

x) And TPEC systems may be milled on construction sites with earthen materials to create composite earthen and synthetic systems.

xi) And TPEC systems may be graded to achieve certain elevations with bulldozers, rollers, graders and other types of conventional construction equipment.

xii) And TPEC particles may be made in various shapes and sizes to include spheres, triangles, squares, pentagons, hexagons, octagons;

xiii) And TPEC systems may be made with hooks and circles to provide a means of creating an interlocking mechanism system.

xiv) And TPEC systems may be used in conjunction with various types of tensile structures to include nettings and fabrics placed within the cross sectional thickness in order to prevent or minimize vertical migration and or horizontal movement of TPEC.

xv) And TPEC systems may be used in gradation to offer more fluid transmissibility

xvi) And TPEC systems may be used in gradations to offer less fluid transmissibility.

xvii) And TPEC systems may be used around perforated pipe.

What is claimed is:

1) A method for providing foraminous drainage structures in close proximity to a building or other large structure, comprising the steps of:
a) processing vehicle tires into particles of a plurality of known sizes,
b) sorting said particles into categories based upon their physical properties,
c) combining said particles to form an aggregate of desired characteristics, and
d) placing said aggregate in close proximity to said building or other large structure.

2) The method of claim 1, wherein said physical properties of said particles are one or more from the group consisting of shape, size, color, compressive strength, flexibility, frictional characteristics such as resistance to flow, porosity, permeability, rigidity, resistance to heat transfer or other insulation index, chemical compatibility, density, elasticity, compactability, compressibility, permeability to the flow of gases or liquids, tensile strength, resistance to chemical degradation, resistance to degradation by microbes, resistance to degradation by visible or non-visible light, resistance to degradation by nuclear radiation, and compressive resistance.

3) The method of claim 1, wherein the respective positions of said particles of said aggregate are not fixed in relation to one another.

4) The method of claim 1, wherein the respective positions of said particles of said aggregate are fixed in relation to one another by bonding.

5) The method of claim 1, wherein said bonding is achieved by means of one or more from the group consisting of adhesives, compression, heat welding, electron beam welding and solvent welding.

6) The method of claim 1, wherein said particles are of a uniform size.

7) The method of claim 1, wherein said particles are of a non-uniform sizes.

8) The method of claim 1, wherein after step a) and before step b), said particles are subjected to preliminary processing.

9) The method of claim 8, wherein said preliminary processing is effected by one or more from the group consisting of exposure to heat and exposure to chemicals.

10) The method of claim 1, wherein said particles are formed into a shape by bonding.

11) The method of claim 10, wherein said bonding is achieved by means of one or more from the group consisting of adhesives, pressure, heat welding, electron beam welding and solvent welding.

12) The method of claim 1, wherein said particles are formed into a shape by means of an enclosure comprising one or more materials from the group consisting of burlap or other conventional fabrics and scrims, nettings of fabric, metal or polymers, geosynthetic rolled good materials such as geotextiles, geocomposites, geogrids, polymeric tensile elements in roll or random form, and geomembranes.

13) The method of claim 12, wherein the respective positions of said particles of said aggregate are fixed in relation to one another by said enclosure.

14) The method of claim 12, wherein said enclosure is permeable to fluids.

15) The method of claim 12, wherein said enclosure is impermeable to fluids.

16) The method of claim 12, wherein said enclosure comprises at least two ends, said two ends being disposed substantially opposite one another, and wherein each of said two ends is provided with apertures suitable for the transmission of fluids.

17) The method of claim 12, wherein said enclosure comprises a drainage structure.

18) The method of claim 12, wherein said one or more materials are initially held in said shape by one or more fasteners.

19) The method of claim 18, wherein said one or more fasteners is selected from the group consisting of welded joints, sewing fibers, ties, and clamps.
